(19) United States
(12) Patent Application Publication
(10) Pub. No.: US 2024/0094456 A1
(43) Pub. Date: Mar. 21, 2024

(54) IMAGE LIGHT GUIDE WITH COMPOUND IN-COUPLING DIFFRACTIVE OPTIC

(71) Applicant: Vuzix Corporation, West Henrietta, NY (US)

(72) Inventor: Robert J. Schultz, Victor, NY (US)

(21) Appl. No.: 18/273,668

(22) PCT Filed: Jan. 21, 2022
(86) PCT No.: PCT/US2022/013329

§ 371 Date: Jul. 21, 2023

Related U.S. Application Data
(60) Provisional application No. 63/140,432, filed on Jan. 22, 2021.

(51) Int. Cl. F21V 8/00

(52) U.S. Cl. CPC G02B 6/0016; G02B 6/0036; G02B 6/0076; G02B 27/0172

(57) ABSTRACT

An image light guide for conveying a virtual image including a substrate operable to propagate image-bearing light beams along a length thereof. An in-coupling diffractive optic is formed along the substrate and is operable to diffract image-bearing light beams from an image source into the substrate in an angularly encoded form. An out-coupling diffractive optic is formed along the substrate, wherein the out-coupling diffractive optic is operable to diffract the image-bearing light beams from the substrate in an angularly decoded form. The in-coupling diffractive optic having three pluralities of periodic in-coupling diffractive structures and the out-coupling diffractive optic having at least two pluralities of periodic out-coupling diffractive structures. The two pluralities of periodic out-coupling diffractive structures being parallel with two of the three pluralities of periodic in-coupling diffractive structures.

### TECHNICAL FIELD

The present disclosure relates generally to electronic displays and more particularly to displays utilizing image light guides with diffractive optics to convey image-bearing light to a viewer.

### BACKGROUND

Head-Mounted Displays (HMDs) and virtual image near-eye displays are being developed for a range of diverse uses, including military, commercial, industrial, firefighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

Although conventional image light guide arrangements have provided significant reduction in bulk, weight, and overall cost of near-eye display optics, further improvements are needed. In some instances, the size of the eyebox is constrained, forcing HMD designs to limit tolerances for movement and device placement. Additionally, light can often be unevenly distributed over the visual field, leading to hot spots, such as higher levels of light within the center of the visual field and lower light levels within the visual field periphery. Another difficulty with conventional image light guide arrangements relates to beam management functions within the waveguide. For example, beam expansion and light distribution functions can increase the size of waveguides as well as their manufacturing cost and complexity.

### SUMMARY

In a first exemplary embodiment, an image light guide for conveying a virtual image includes a substrate operable to propagate image-bearing light beams along a length thereof. An in-coupling diffractive optic is formed along the substrate and is operable to diffract image-bearing light beams into the substrate in an angularly encoded form. An out-coupling diffractive optic is formed along the substrate, wherein the out-coupling diffractive optic is operable to diffract the image-bearing light beams from the substrate in an angularly decoded form. The in-coupling diffractive optic has three pluralities of periodic diffractive structures, and the out-coupling diffractive optic has at least two pluralities of periodic diffractive structures. The two pluralities of periodic diffractive structures of the out-coupling diffractive optic are parallel with two of the three pluralities of periodic diffractive structures of the in-coupling diffractive optic.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 shows a schematic side view of an image light guide with an exaggerated thickness for showing the propagation of light from an image source along the image light guide to an eyebox within which the virtual image can be viewed.

FIG. 2 shows a schematic perspective view of an image light guide including an in-coupling diffractive optic, a turning diffractive optic, and out-coupling diffractive optic for managing the propagation of image-bearing light beams.

FIG. 3A shows a schematic plan view of an image light guide having an in-coupling diffractive optic with three patterns of periodic diffractive structures according to an exemplary embodiment of the presently disclosed subject matter.

FIG. 3B shows a schematic plan view of an image light guide having an in-coupling diffractive optic with three patterns of periodic diffractive structures and an out-coupling diffractive optic with three patterns of periodic diffractive structures according to an exemplary embodiment of the presently disclosed subject matter.

FIGS. 4A and 4B shows a schematic plan view of an image light guide having an intermediate diffractive optic at least partially located about the in-coupling diffractive optic according to an exemplary embodiment of the presently disclosed subject matter.

FIG. 5 shows a schematic plan view of an image light guide having in-coupling and out-coupling diffractive optics configured as a single continuous diffractive pattern.

FIG. 6 shows a schematic of a portion of a compound diffraction pattern operable to expand and out-couple image-bearing beams according to an exemplary embodiment of the presently disclosed subject matter.

FIG. 7 shows an imaging light guide system having a waveguide stack according to an exemplary embodiment of the presently disclosed subject matter.

FIG. 8 shows a near-eye display system for augmented reality viewing using imaging light guides according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where they are used herein, the terms “first”, “second”, and so on, do not necessarily denote any ordinal, sequential, or priority relation, but are simply used to more clearly distinguish one element or set of elements from another, unless specified otherwise.

Where used herein, the term “exemplary” is meant to indicate “an example of”, and is not intended to suggest any preferred or ideal embodiment.

Where used herein, the terms “viewer”, “operator”, “observer”, and “user” are considered equivalents and refer to the person or machine who wears and/or views images using a device having an imaging light guide.

Where used herein, the term “set” refers to a non-empty set, as the concept of a collection of elements or members of a set is widely understood in elementary mathematics. The term “subset”, unless otherwise explicitly stated, is used herein to refer to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the term “beam expansion” is intended to mean replication of a beam via multiple encounters with an optical element to provide exit pupil expansion in one or more directions. Similarly, as used herein, to “expand” a beam, or a portion of a beam, is intended to mean replication of a beam via multiple encounters with an optical element to provide exit pupil expansion in one or more directions.

An optical system, such as a HMD, can produce a virtual image. In contrast to methods for forming a real image, a virtual image is not formed on a display surface. That is, if a display surface were positioned at the perceived location of a virtual image, no image would be formed on that surface. Virtual images have a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or buried within the waveguide. Such diffractive optics can be formed as diffraction gratings, holographic optical elements (HOEs) or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along one dimension of the virtual image. In addition, a turning grating can be positioned on/in the waveguide to provide pupil expansion in an orthogonal dimension of the virtual image. The image-bearing light output from the waveguide provides an expanded eyebox for the viewer.

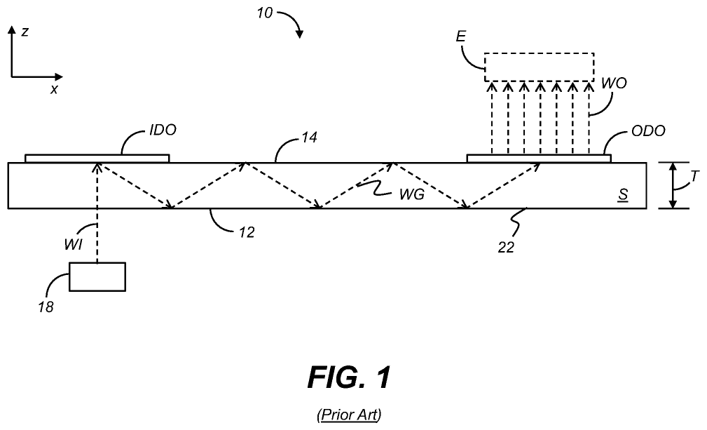

As illustrated in FIG. 1, an image light guide 10 may comprise a planar waveguide 22 having plane-parallel surfaces 12, 14. The waveguide 22 includes a transparent substrate S, which, for example, can be made of optical glass or plastic, having plane parallel front and back surfaces 12, 14. In this example, an in-coupling diffractive optic IDO and an out-coupling diffractive optic ODO are arranged on the back surface 14. The in-coupling diffractive optic IDO is a reflective-type diffraction grating operable to couple image-bearing light WI into the planar waveguide 22. However, the in-coupling diffractive optic IDO could alternately be a volume hologram or other holographic diffraction element, or other type of optical component that provides diffraction for the incoming, image-bearing light WI. The in-coupling diffractive optic IDO can be located on the front surface 12 or the back surface 14 of the planar waveguide 22 and can be of a transmissive or reflective-type depending, at least in part, upon the direction from which the image-bearing light WI approaches the planar waveguide 22.

When used as a part of a near-eye display system, the in-coupling diffractive optic IDO couples the image-bearing light WI from a real, virtual or hybrid image source 18 into the substrate S of the planar waveguide 22. Any real image or image dimension is first converted into an array of overlapping angularly related beams encoding the different positions within an image for presentation to the in-coupling diffractive optic IDO. Typically, the rays within each bundle forming one of the angularly related beams extend in parallel, but the angularly related beams are relatively inclined to each other through angles that can be defined in two angular dimensions corresponding to linear dimensions of the image.

The image-bearing light WI is diffracted (generally through a first diffraction order) and thereby redirected by in-coupling diffractive optic IDO into the planar waveguide 22 as angularly encoded image-bearing light beams WG for further propagation along a length dimension X of the planar waveguide 22 by Total Internal Reflection (“TIR”) from the plane parallel front and back surfaces 12, 14. Although diffracted into a generally more condensed range of angularly related beams in keeping with the boundaries set by TIR, the image-bearing light WG preserves the image information in an angularly encoded form that is derivable from the parameters of the in-coupling diffractive optic IDO. The out-coupling diffractive optic ODO receives the encoded image-bearing light WG and diffracts (also generally through a first diffraction order) the image-bearing light WG out of the planar waveguide 22 as the image-bearing light WO toward a region of space referred to as an eyebox E, within which the transmitted virtual image can be seen by a viewer's eye. Generally, the out-coupling diffractive optic ODO is designed symmetrically with respect to the in-coupling diffractive optic IDO to restore the original angular relationships of the image-bearing light WI among outputted angularly related beams of the image-bearing light WO. However, to increase one dimension of overlap among the angularly related beams populating the eyebox E within which the virtual image can be seen, the out-coupling diffractive optic ODO is arranged, together with a limited thickness T of the planar waveguide 22, to encounter the image-bearing light WG multiple times and to diffract only a portion of the image-bearing light WG on each encounter. The multiple encounters along the length of the out-coupling diffractive optic ODO have the effect of enlarging one dimension of each of the angularly related beams of the image-bearing light WO (i.e., beam expansion) thereby expanding one dimension of the eyebox E within which the beams overlap. The expanded eyebox E decreases sensitivity to the position of a viewer's eye for viewing the virtual image. Embodiments of the out-coupling diffractive optic ODO can modify the original field points' positional angular relationships producing an output virtual image at a finite focusing distance.

As described above, out-coupling diffractive optics with refractive index variations along a single dimension can expand one dimension of the eyebox by replicating the individual angularly related beams in their direction of propagation along the waveguide between encounters with the out-coupling diffractive optic. In addition, out-coupling diffractive optics with refractive index variations along a second dimension can expand a second dimension of the eyebox and provide two-dimensional expansion of the eyebox. The refractive index variations along a first dimension of the out-coupling diffractive optic can be arranged to diffract a portion of each beam's energy out of the waveguide upon each encounter therewith through a desired first order of diffraction, while another portion of the beam's energy is preserved for further propagation in its original direction through a zero order of diffraction. The refractive index variations along a second dimension of the out-coupling diffractive optic can be arranged to diffract a portion of each beam's energy upon each encounter therewith through a desired first order of diffraction in a direction angled relative to the beam's original direction of propagation, while another portion of the beam's energy is preserved for further propagation in its original direction through a zero order of diffraction.

The out-coupling diffractive optic ODO is shown as a transmissive-type diffraction grating arranged on the back surface 14 of the planar waveguide 22. However, like the in-coupling diffractive optic IDO, the out-coupling diffractive optic ODO can be located on the front surface 12 or the back surface 14 of the planar waveguide 22 and be of a transmissive or reflective-type in a combination that depends, at least in part, upon the direction through which the image-bearing light WG is intended to exit the planar waveguide 22.

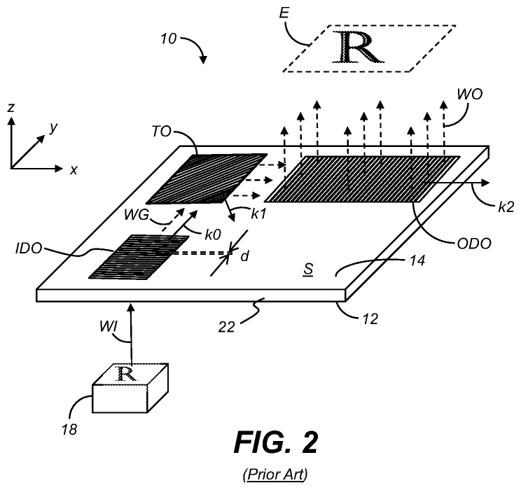

As illustrated in FIG. 2, an image light guide 10 may be arranged for expanding an eyebox E in two dimensions, i.e., along both x- and y-axes of the intended image. To achieve a second dimension of beam expansion, the in-coupling diffractive optic IDO, having a grating vector k0, is oriented to diffract a portion of the image-bearing light WI toward an intermediate optic TO, having a grating vector k1, which is oriented to diffract a portion of the image-bearing light WG in a reflective mode toward the out-coupling diffractive optic ODO. The intermediate optic TO may be referred to herein as a turning grating or turning optic. In an embodiment, the intermediate optic TO is a surface relief grating. In another embodiment, the intermediate optic TO is a holographic optical element. Only a portion of the image-bearing light WG is diffracted by each of multiple encounters with intermediate optic TO thereby replicating each of the angularly related beams of the image-bearing light WG in one or more dimensions, providing pupil expansion in one or more dimensions. The intermediate optic may also, or instead, turn the direction of propagation of at least a portion of image-bearing light beams WG traveling within the waveguide 22. The intermediate optic TO redirects the image-bearing light WG toward the out-coupling diffractive optic ODO for longitudinally expanding the eyebox E in a second dimension before exiting the planar waveguide 22 as the image-bearing light WO. Grating vectors, such as the depicted grating vectors k0, k1, k2, extend in a direction that is normal to the diffractive features (e.g., grooves, lines, or rulings) of the diffractive optics and have a magnitude inverse to the period or pitch d (i.e., the on-center distance between grooves) of the diffractive optics IDO, TO, ODO. The in-coupling diffractive optic IDO, the intermediate optic TO, and the out-coupling diffractive optic ODO may each have a different period or pitch d. The intermediate optic TO may instead comprise a reflector array as described in US 2021/0215941 A1, incorporated herein by reference in its entirety.

As illustrated in FIG. 2, the in-coupling diffractive optic IDO receives the incoming image-bearing light WI containing a set of angularly related beams corresponding to individual pixels or equivalent locations within an image generated by an image source 18, such as a projector. The image source 18, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. The image light guide 10 outputs an expanded set of angularly related beams in two dimensions of the image by providing multiple encounters of the image-bearing light WG with both the intermediate optic TO and the out-coupling diffractive optic ODO in different orientations. In the original orientation of the planar waveguide 22, the intermediate optic TO provides beam expansion in the y-axis direction, and the out-coupling diffractive optic ODO provides a similar beam expansion in the x-axis direction. The reflectivity characteristics and respective periods d of the diffractive optics IDO, ODO, TO, together with the orientations of their respective grating vectors, provide for exit pupil expansion in two dimensions while preserving the intended relationships among the angularly related beams of the image-bearing light WI that are output from the image light guide 10 as the image-bearing light WO.

While the image-bearing light WI input into the image light guide 10 is encoded into a different set of angularly related beams by the in-coupling diffractive optic IDO, the information required to reconstruct the image is preserved by accounting for the systematic effects of the in-coupling diffractive optic IDO. The intermediate optic TO, located in an intermediate position between the in-coupling and out-coupling diffractive optics IDO, ODO, is typically arranged so that it does not induce any significant change on the encoding of the image-bearing light WG. The out-coupling diffractive optic ODO is typically arranged in a symmetric fashion with respect to the in-coupling diffractive optic IDO, e.g., including diffractive features sharing the same period. Similarly, the period of the intermediate optic TO also typically matches the common period of the in-coupling and out-coupling diffractive optics IDO, ODO. As illustrated in FIG. 2, the grating vector k1 of the intermediate optic TO may be oriented at 45 degrees with respect to the other grating vectors k0, k2 (all as undirected line segments). However, in an embodiment, the grating vector k1 of the intermediate optic TO is oriented at 60 degrees to the grating vectors k0, k2 of the in-coupling and out-coupling diffractive optics IDO, ODO in such a way that the image-bearing light WG is turned 120 degrees. By orienting the grating vector k1 of the intermediate optic TO at 60 degrees with respect to the grating vectors k0, k2 of the in-coupling and out-coupling diffractive optics IDO, ODO, the grating vectors k0, k2 are also oriented at 60 degrees with respect to each other (again considered as undirected line segments). Basing the grating vector magnitudes on the common pitch of the intermediate optic TO and the in-coupling and out-coupling diffractive optics IDO, ODO, the three grating vectors k0, k1, k2 (as directed line segments) form an equilateral triangle, and sum to a zero-vector magnitude, which avoids asymmetric effects that could introduce unwanted aberrations including chromatic dispersion.

The image-bearing light WI that is diffracted into the planar waveguide 22 is effectively encoded by the in-coupling diffractive optic IDO, whether the in-coupling diffractive optic IDO uses gratings, holograms, prisms, mirrors, or some other mechanism. Any reflection, refraction, and/or diffraction of light that takes place at the in-coupling diffractive optic IDO must be correspondingly decoded by the out-coupling diffractive optic ODO to re-form the virtual image that is presented to the viewer. The intermediate optic TO, placed at an intermediate position between the in-coupling and out-coupling diffractive optics IDO, ODO, is typically designed and oriented so that it does not induce any change on the encoded light. The out-coupling diffractive optic ODO decodes the image-bearing light WG into its original or desired form of angularly related beams that have been expanded to fill the eyebox E.

Whether any symmetries are maintained or not among the intermediate optic TO and the in-coupling and out-coupling diffractive optics IDO, ODO or whether any change to the encoding of the angularly related beams of the image-bearing light WI takes place along the planar waveguide 22, the intermediate optic TO and the in-coupling and out-coupling diffractive optics IDO, ODO are related so that the image-bearing light WO that is output from the planar waveguide 22 preserves or otherwise maintains the original or desired form of the image-bearing light WI for producing the intended virtual image.

The letter “R” represents the orientation of the virtual image that is visible to the viewer whose eye is in the eyebox E. As shown, the orientation of the letter “R” in the represented virtual image matches the orientation of the letter “R” as encoded by the image-bearing light WI. A change in the rotation about the z axis or angular orientation of incoming image-bearing light WI with respect to the x-y plane causes a corresponding symmetric change in rotation or angular orientation of outgoing light from out-coupling diffractive optic ODO. From the aspect of image orientation, the intermediate optic TO typically acts as a type of optical relay, providing expansion of the angularly encoded beams of the image-bearing light WG along one axis (e.g., along the y-axis) of the image. The out-coupling diffractive optic ODO further expands the angularly encoded beams of the image-bearing light WG along another axis (e.g., along the x-axis) of the image while maintaining the original orientation of the virtual image encoded by the image-bearing light WI. As illustrated in FIG. 2, the intermediate optic TO may be a slanted or square grating arranged on the front or back surfaces of the planar waveguide 22. Alternately, the intermediate optic TO may be a blazed grating.

The present disclosure provides for an image light guide having improved diffraction efficiency and image-bearing light output intensity across the output aperture. More specifically, the present disclosure provides for, inter alia, a waveguide having a compound in-coupling diffractive optic and a compound out-coupling diffractive optic operable to expand image-bearing light beams in two-dimensions and output the expanded image-bearing light beams toward an eyebox.

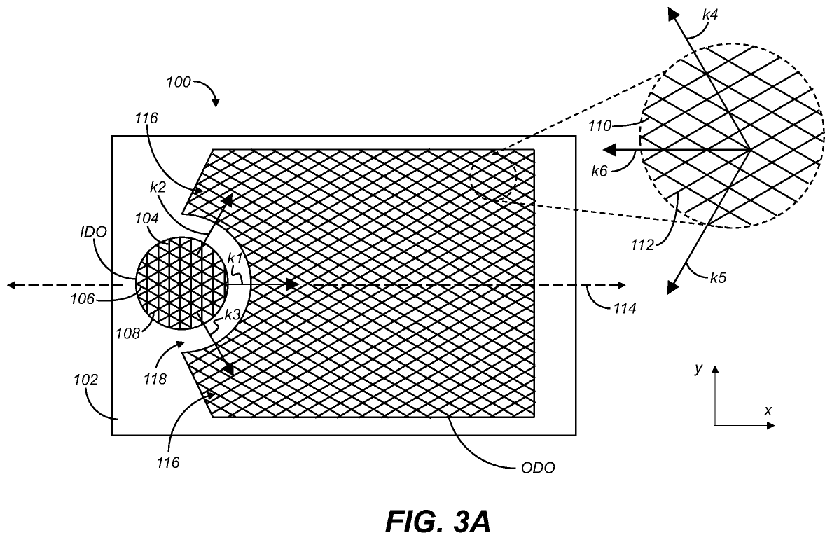

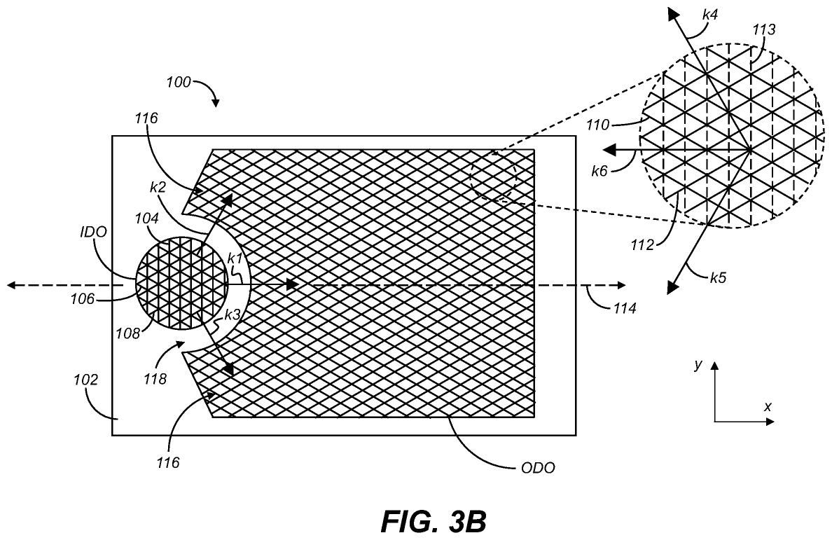

As illustrated in FIG. 3A, in an embodiment, an image light guide 100 may have an in-coupling diffractive optic IDO and an out-coupling diffractive optic ODO formed on/in a first surface 102 of the image light guide 100. Alternately, one or both of the in-coupling and out-coupling diffractive optics IDO, ODO can be formed on/in the second surface of the image light guide 100 located opposite the first surface 102. In an embodiment, the in-coupling diffractive optic IDO comprises multiple sets of periodic diffractive structures. For example, the in-coupling diffractive optic IDO may comprise a first set of periodic in-coupling linear grating structures 104 parallel with the y-axis, a second set of periodic in-coupling linear grating structures 106 rotated/offset sixty-degrees (60°) relative to the first set of periodic linear grating structures 104, and a third set of periodic in-coupling linear grating structures 108 rotated/offset negative sixty-degrees (−60°) relative to the first set of periodic in-coupling linear grating structures 104. The first set of periodic in-coupling diffractive structures 104 have a grating vector k1 extending normal to the periodic diffractive structures 104. The second and third sets of periodic in-coupling diffractive structures 106, 108 have second and third grating vectors k2, k3 extending normal to the periodic in-coupling diffractive structures 106, 108, respectively. In an embodiment, the first set of periodic in-coupling diffractive structures 104 has a different periodicity than the second and third sets of periodic in-coupling diffractive structures 106, 108.

In an embodiment, the out-coupling diffractive optic ODO comprises first and second sets of periodic out-coupling diffractive structures 110, 112. The first and second sets of periodic out-coupling diffractive structures 110, 112 form a compound diffractive optic operable to expand and out-couple image-bearing light from the out-coupling diffractive optic ODO. In an embodiment, the first and second sets of periodic out-coupling diffractive structures 112 comprise diffraction gratings (e.g., linear rulings) and the diffraction gratings of the first set of periodic out-coupling diffractive structures 110 are crossed with the diffraction gratings of the second set of periodic out-coupling diffractive structures 112. In an embodiment, as illustrated in FIG. 3A, the first set of periodic out-coupling diffractive structures 110 are parallel with the second set of periodic in-coupling diffractive structures 106 and the second set of periodic out-coupling diffractive structures 112 are parallel with the third set of periodic in-coupling diffractive structures 108. The first set of periodic out-coupling diffractive structures 110 may also have the same periodicity as the second set of periodic in-coupling diffractive structures 106, and the second set of periodic out-coupling diffractive structures 112 may have the same periodicity as the third set of periodic in-coupling diffractive structures 108. In an embodiment, the out-coupling diffractive optic ODO has bilateral symmetry across a longitudinal axis 114.

The first and second sets of periodic out-coupling diffractive structures 110, 112 have fourth and fifth grating vectors k4, k5 extending normal to the periodic diffractive structures 110, 112, respectively. In an embodiment, the grating vector k4 is offset from the in-coupling grating vector k1 and from the x-axis by sixty-degrees (+60°), and the grating vector k5 is offset from the in-coupling grating vector k1 and the x-axis by negative sixty-degrees (−60°).

In operation, at least a portion of image-bearing light beams incident upon the first, second, and third sets of periodic in-coupling diffractive structures 104, 106, 108 undergo diffraction and are directed into the image light guide 100 as image-bearing light WG for further propagation within the image light guide 100 by TIR and/or by diffraction reflection. To illustrate one or more properties of the presently disclosed embodiments, the image light guide 100 is described below, inter alia, in terms of the optical paths of one or more portions of a beam of image-bearing light WI that is arranged normal to the plane of the in-coupling diffractive optic IDO when incident thereon, unless otherwise stated. However, persons skilled in the art will recognize that these descriptions are not limiting, and that the image-bearing light WI incident upon the in-coupling diffraction optic IDO may be arranged at any angle for which the system is optimized.

For example, where a central ray of a beam of image-bearing light WI is incident upon the in-coupling diffractive optic IDO along the normal to the in-coupling diffractive optic IDO, a portion of the image-bearing light WI is incident upon each of the first, second, and third sets of periodic in-coupling diffractive structures 104, 106, 108. In this example, portions of the image-bearing light WI are directed parallel to the directions of the first grating vector k1, the second grating vector k2, and the third grating vector k3 towards the out-coupling diffractive optic ODO. The second set of periodic in-coupling diffractive structures 106 and the third set of periodic in-coupling diffractive structures 108 direct portions of the image-bearing light toward the outer regions (in the y-axis direction) of the out-coupling diffractive optic ODO. Directing portions of the image-bearing light incident upon the in-coupling diffractive optic IDO toward the outer regions (in the y-axis direction) of the out-coupling diffractive optic ODO reduces the intensity of the image-bearing light out-coupled from the center (in the y-axis direction) of the out-coupling diffractive optic ODO. This configuration reduces or eliminates a so-called hotspot in the eyebox.

As illustrated in the detail view of FIG. 3B, in an embodiment, the out-coupling diffractive optic ODO includes a third set of periodic out-coupling diffractive structures 113 having a sixth grating vector k6 extending normal to the periodic diffractive structures 113. The grating vector k6 is parallel with the in-coupling grating vector k1 and the x-axis. The first, second, and third sets of periodic out-coupling diffractive structures 110, 112, 113 are configured to preserve the symmetry of at least a portion of the image-bearing light in-coupled by the first set of periodic in-coupling diffractive structures 104. For example, the pitch of the third set of periodic out-coupling diffractive structures 113 is generally complimentary to the pitch of the first set of periodic in-coupling diffractive structures 104. In an embodiment, the third set of periodic out-coupling diffractive structures 113 are formed with a shallower depth than the first and second sets of periodic out-coupling diffractive structures 110, 112 to decrease the diffraction efficiency of the third set of periodic out-coupling diffractive structures 113 relative to the first and second sets of periodic out-coupling diffractive structures 110, 112. This configuration reduces the prominence of the third set of periodic out-coupling diffractive structures 113 and decreases the image-bearing light WG outcoupled thereby to increase light distribution to the outer edges of the out-coupling diffractive optic ODO in the y-axis direction.

Referring back to FIG. 3A, in an embodiment, the sixth grating vector k6 is implicitly defined by the first and second sets of periodic out-coupling diffractive structures 110, 112. An out-coupling diffractive optic ODO having an implicitly described third set of periodic out-coupling diffractive structures decreases, but does not eliminate, the image-bearing light WG outcoupled from these implied diffractive structures to increase light distribution to the outer edges of the out-coupling diffractive optic ODO in the y-axis direction. In one embodiment, where the periodic out-coupling diffractive structures 110, 112 are linear gratings or holographic diffractive structures, at least a portion of the image-bearing light WG propagating along the direction of the first grating vector k1 is diffracted out of the image light guide 100 via incidence upon one or more diffractive structures of the first or second set of periodic out-coupling diffractive structures 110, 112. For example, at least a portion of the image-bearing light propagating along the direction of the first grating vector k1 is out-coupled upon incidence with a location where the first and second sets of periodic out-coupling diffractive structures 110, 112 are coincident.

With continued reference to FIG. 3A, in an embodiment, a portion 116 of the out-coupling diffractive optic ODO wraps about the in-coupling diffractive optic IDO. In other words, the portions 116 of the out-coupling diffractive optic ODO extend at least partially about the in-coupling diffractive optic IDO such that a beam of image-bearing light incident upon the in-coupling diffractive optic IDO perpendicular to the plane thereof is diffracted and portions of the image-bearing light WG are directed parallel to the second and third grating vectors k2, k3 and are incident upon the portions 116 of the out-coupling diffractive optic ODO. As illustrated in FIG. 3A, in an embodiment, the out-coupling diffractive optic ODO and the in-coupling diffractive optic IDO are laterally separated in the x-axis and y-axis directions by a space 118. The space 118 may be arcuate and does not include any periodic diffractive structures.

In an embodiment, the depth of the periodic diffractive structures 106, 108, 110, 112 in the in-coupling diffractive optic IDO and the out-coupling diffractive optic ODO is the same. In another embodiment, the depth of periodic diffractive structures 104, 106, 108, 110, 112 are varied to increase the efficiency of selected orders of diffraction. For example, the second and third sets of periodic in-coupling diffractive structures 106, 108 may have a greater depth than the first set of periodic in-coupling diffractive structures 104 and the first and second sets of periodic out-coupling diffractive structures 110, 112.

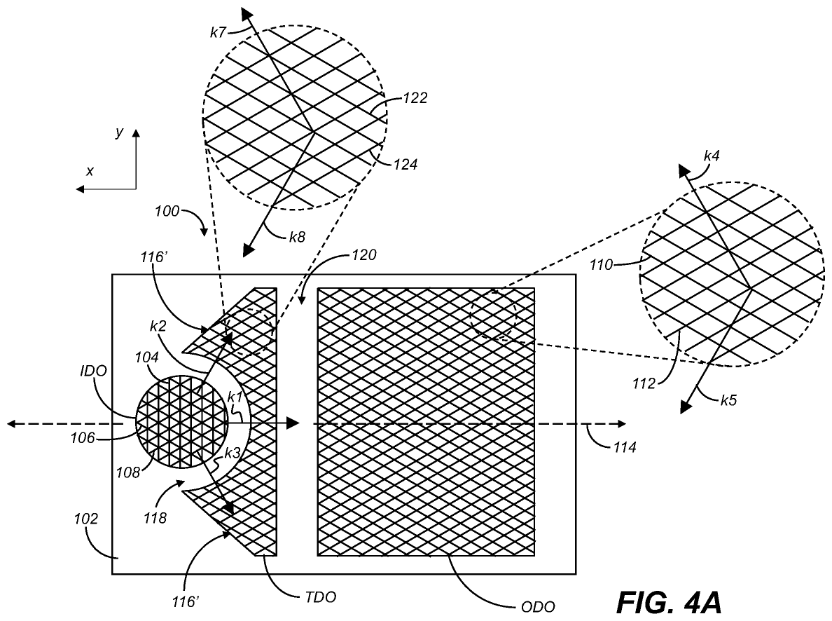

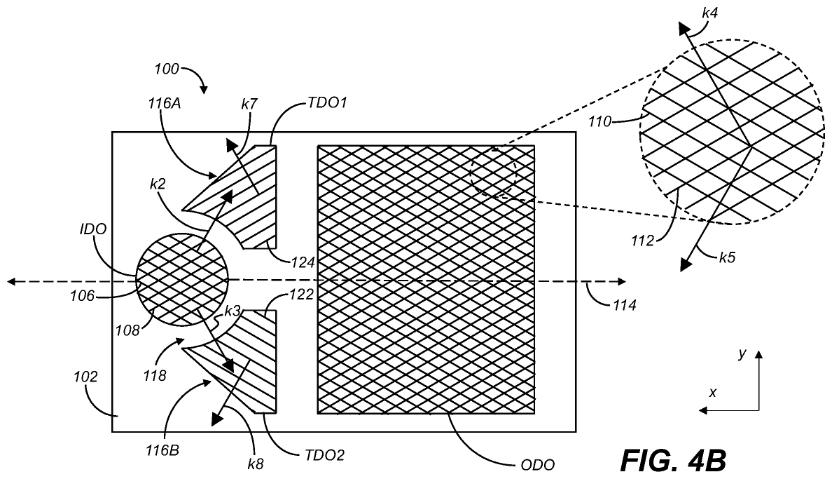

As illustrated in FIG. 4A, in an embodiment, the image light guide 100 may include an intermediate diffractive optic TDO formed on/in the first surface 102 of the image light guide 100. Alternately, the intermediate diffractive optic TDO may be formed on/in the second surface of the image light guide 100 located opposite the first surface 102. The intermediate diffractive optic TDO is located in the path of the image-bearing light WG between the in-coupling diffractive optic IDO and the out-coupling diffractive optic ODO. The intermediate diffractive optic TDO and the in-coupling diffractive optic IDO are laterally separated in the x-axis and y-axis directions by the space 118. A portion 116′ of the intermediate diffractive optic TDO wraps about the in-coupling diffractive optic IDO. In other words, the portion 116′ of the intermediate diffractive optic TDO extends at least partially about the in-coupling diffractive optic IDO such that portions of the image-bearing light WG directed generally parallel with the second and third grating vectors k2, k3 are incident upon the portion 116′ of the intermediate diffractive optic TDO.

With continued reference to FIG. 4A, the intermediate diffractive optic TDO and the out-coupling diffractive optic ODO are laterally separated in the x-axis direction by a second space 120. The intermediate diffractive optic TDO comprises first and second sets of periodic intermediate diffractive structures 122, 124. In an embodiment, the first and second sets of periodic intermediate diffractive structures 122, 124 have the same orientation, periodicity, and symmetry as the first and second sets of periodic out-coupling diffractive structures 110, 112. In an embodiment, the grating vectors k7, k8 of the first and second sets of periodic intermediate diffractive structures 122, 124 are equal in magnitude and direction to the grating vectors k4, k5. In another embodiment, the grating vectors k7, k8 of the first and second sets of periodic intermediate diffractive structures 122, 124 have different magnitude and direction than the grating vectors k4, k5. One advantage of the intermediate diffractive optic TDO is greater freedom in the positioning of the out-coupling diffractive optic ODO.

A portion of the image-bearing light incident upon the first and second sets of periodic intermediate diffractive structures 122, 124 may be out-coupled from the image light guide 100. However, this image-bearing light that is out-coupled at the intermediate diffractive optic TDO is outside of the eyebox, and therefore does not affect the formation of the virtual image.

As illustrated in FIG. 4B, in an embodiment, the in-coupling diffractive optic IDO comprises two pluralities of periodic diffractive structures 106, 108. For example, the in-coupling diffractive optic IDO may include a first set of periodic linear grating structures 106 rotated/offset relative to the x-axis by an angle less than thirty degrees (e.g., 25°), and a second set of periodic linear grating structures 108 rotated/offset relative to the x-axis by an angle less than negative thirty degrees (e.g., −25°). The first and second sets of periodic in-coupling grating structures 106, 108 are crossed. The first set of periodic in-coupling diffractive structures 106 comprises a first period, and the second set of periodic in-coupling diffractive structures 108 comprises a second period. In an embodiment, the second period is equal to the first period. The first set of periodic in-coupling diffractive structures 106 defines a first grating vector k2 and the second set of periodic in-coupling diffractive structures 108 defines a second grating vector k3.

The image light guide 100 includes a first intermediate diffractive optic TDO1 located at least partially within the path of a portion of in-coupled image-bearing light WG. In an embodiment, where the image-bearing light is incident upon the in-coupling diffractive optic IDO generally perpendicular to the plane thereof, the first intermediate diffractive optic TDO1 is located at least partially within the path of image-bearing light propagating generally parallel with the first grating vector k2. The portion 116A of the first intermediate diffractive optic TDO1 extends at least partially about the in-coupling diffractive optic IDO such that image-bearing light diffracted generally parallel with the first grating vectors k2 is incident upon the portion 116A of the first intermediate diffractive optic TDO1. The image light guide 100 also includes a second intermediate diffractive optic TDO2 located at least partially within the path of a portion of in-coupled image-bearing light WG. In an embodiment, where the image-bearing light is incident upon the in-coupling diffractive optic IDO generally perpendicular to the plane thereof, the second intermediate diffractive optic TDO2 is located at least partially within the path of image-bearing light propagating generally parallel with the second grating vector k3. The portion 116B of the second intermediate diffractive optic TDO2 extends at least partially about the in-coupling diffractive optic IDO such that image-bearing light diffracted generally parallel with the second grating vectors k3 is incident upon the portion 116B of the second intermediate diffractive optic TDO2.

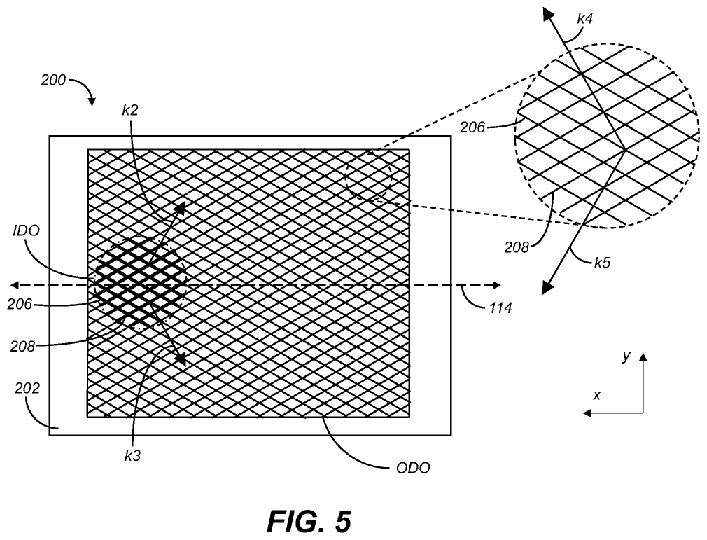

As illustrated in FIG. 5, an image light guide 200 may have an in-coupling diffractive optic IDO and an out-coupling diffractive optic ODO formed on/in a first surface 202 of the image light guide 200. The in-coupling diffractive optic IDO and the out-coupling diffractive optic ODO may be configured as a single continuous diffractive pattern having a first set of periodic linear grating structures 206 rotated/offset sixty-degrees (60°) relative to the y-axis direction, and a second set of periodic linear grating structures 208 rotated/offset negative sixty-degrees (−60°) relative to the y-axis direction. In an embodiment, the depth of the first and second sets of periodic linear grating structures 206, 208 comprising the in-coupling diffractive optic IDO have a greater depth than the periodic linear grating structures 206, 208 comprising the out-coupling diffractive optic ODO. In diffractive optics comprising diffraction gratings, increasing grating depth results in improved diffraction efficiency.

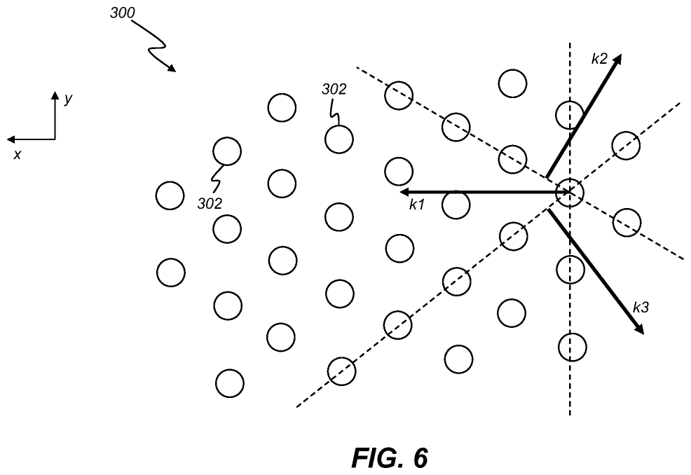

In embodiments of the present disclosure, the periodic structures may be, but are not limited to, straight line diffractive features, circular posts, or elliptical posts. For example, FIG. 6 shows a compound diffractive pattern 300 having diffractive features comprising circular posts 302. The in-coupling diffractive optic IDO and the out-coupling diffractive optic ODO of the image light guides 100, 200 may similarly be configured.

Persons skilled in the art will recognize that in one or more embodiments of the diffractive patterns illustrated in FIGS. 4A-6, the in-coupling diffractive optic IDO and/or the out-coupling diffractive optic ODO include a third set of periodic diffractive structures 104, 113, where the third set of periodic diffractive structures may be implicit as discussed above with respect to FIG. 3A.

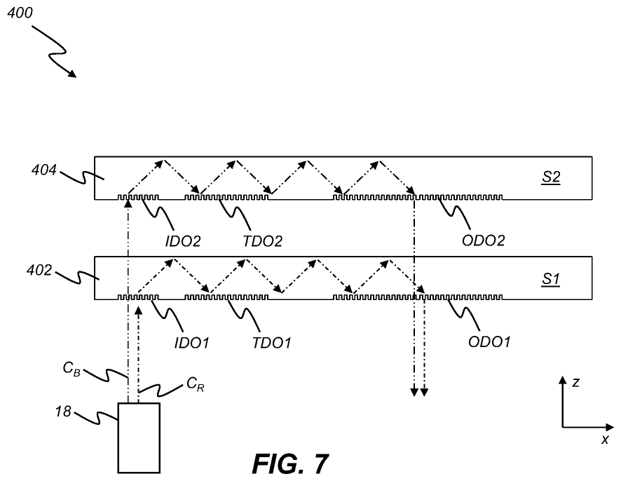

As illustrated in FIG. 7, in an embodiment, a stacked image light guide assembly 400 includes a first image light guide 402 coupled with a second image light guide 404. The first and second image light guides 402, 404 may each be one of the image light guides 100, 200 described supra. The image light guides 402, 404 are formed on separate substrates S1, S2 that are mechanically coupled. For example, the image light guides 402, 404 may be coupled via an adhesive. In an embodiment, the stacked image light guide assembly 400 provides two separate color channels. As illustrated in FIG. 7, the first image light guide 402 has a red channel CR for red light (e.g., in the 630-660 nm range), the second image light guide 404 has a blue channel CB for blue light B (e.g., in the 440-470 nm range). In an embodiment, the first and second image light guides 402, 404 are generally monochrome plates forming the polychromatic image light guide assembly 400.

Blue light from the projector 18 that is incident upon the stacked image light guide assembly 400 transmits through the in-coupling diffractive optic IDO1 of the first image light guide 402 and is diffracted at the in-coupling diffractive optic IDO2 of the second image light guide 404. The diffracted blue light is then conveyed via TIR through the second image light guide substrate S2 and directed to the out-coupling diffractive optic ODO2 of the second image light guide 404. Red light from the projector 18 that is incident upon the stacked image light guide assembly 400 is diffracted at the in-coupling diffractive optic IDO1 of the first image light guide 402. The diffracted red light is then conveyed via TIR through the first image light guide substrate S1 and directed to the out-coupling diffractive optic ODO1 of the first image light guide 402.

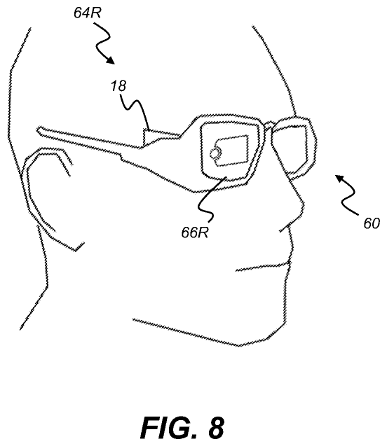

The perspective view of FIG. 8 shows a display system 60 for augmented reality viewing using one or more image light guides of the present disclosure. Display system 60 is shown as an HMD with a right-eye optical system 64R having an image light guide 66R for the right eye. The display system 60 includes an image source 18, such as a picoprojector or similar device, energizable to generate an image. In an embodiment, the display system 60 includes a left-eye optical system including one or more image light guides and a second image source. The images that are generated can be a stereoscopic pair of images for 3-D viewing. The virtual image that is formed by the display system 60 can appear to be superimposed or overlaid onto the real-world scene content seen by the viewer through an image light guide 66R. Additional components familiar to those skilled in the augmented reality visualization arts, such as one or more cameras mounted on the frame of the HMD for viewing scene content or viewer gaze tracking, can also be provided.

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

What is claimed is:

1. An image light guide for conveying a virtual image, comprising:
a substrate operable to propagate image-bearing light beams along a length thereof;
an in-coupling diffractive optic formed along said substrate, wherein said in-coupling diffractive optic is operable to diffract said image-bearing light beams into said substrate in an angularly encoded form; and
an out-coupling diffractive optic formed along said substrate, wherein said out-coupling diffractive optic is operable to diffract said image-bearing light beams from said substrate in an angularly decoded form;
wherein said in-coupling diffractive optic comprises first, second, and third pluralities of periodic in-coupling diffractive structures;
wherein said out-coupling diffractive optic comprises first and second pluralities of periodic out-coupling diffractive structures arranged parallel with said second and third pluralities of periodic in-coupling diffractive structures.

2. The image light guide for conveying a virtual image according to claim 1, wherein said in-coupling diffractive optic defines a first grating vector, a second grating vector, and a third grating vector.

3. The image light guide for conveying a virtual image according to claim 2, wherein said out-coupling diffractive optic defines a fourth grating vector and a fifth grating vector, and said first and second pluralities of periodic out-coupling diffractive structures have a periodicity equivalent to a periodicity of said second and third pluralities of periodic in-coupling diffractive structures.

4. The image light guide for conveying a virtual image according to claim 2, wherein said out-coupling diffractive optic is located in a path of said first grating vector.

5. The image light guide for conveying a virtual image according to claim 1, wherein a portion of said out-coupling diffractive optic is located at least partially about said in-coupling diffractive optic, and an arcuate space is located between said in-coupling diffractive optic and said out-coupling diffractive optic, wherein said arcuate space does not include any periodic diffractive structures.

6. The image light guide for conveying a virtual image according to claim 1, further comprising:
an intermediate diffractive optic located in an optical path between said in-coupling diffractive optic and said out-coupling diffractive optic, wherein said intermediate diffractive optic comprises:
a first plurality of periodic intermediate diffractive structures oriented parallel with said third plurality of periodic in-coupling diffractive structures, and
a second plurality of periodic intermediate diffractive structures oriented parallel with said second plurality of periodic in-coupling diffractive structures,
wherein a portion of said intermediate diffractive optic is located at least partially about said in-coupling diffractive optic, and
an arcuate space is located between said in-coupling diffractive optic and said intermediate diffractive optic, wherein said arcuate space does not include any periodic diffractive structures.

7. The image light guide for conveying a virtual image according to claim 6, wherein a second space is located between said intermediate diffractive optic and said out-coupling diffractive optic, wherein said second space does not include any periodic diffractive structures.

8. The image light guide for conveying a virtual image according to claim 1, wherein said substrate is a first substrate in a stacked image light guide assembly, and a second substrate operable to propagate image-bearing light beams along a length thereof is coupled with said first substrate, wherein said first and second substrates comprise monochromic light channels forming a polychromatic image light guide assembly.

9. The image light guide for conveying a virtual image according to claim 1, wherein each periodic in-coupling diffractive structure of said second plurality of periodic in-coupling diffractive structures is positioned 60° relative to each periodic in-coupling diffractive structure of said first plurality of periodic in-coupling diffractive structures.

10. The image light guide for conveying a virtual image according to claim 9, wherein each periodic in-coupling diffractive structure of said first and second pluralities of periodic in-coupling diffractive structures have a greater depth than each periodic out-coupling diffractive structure of said periodic out-coupling diffractive structures.

11. An image light guide for conveying a virtual image, comprising:
a substrate operable to propagate image-bearing light beams along a length thereof;
an in-coupling diffractive optic formed along said substrate, wherein said in-coupling diffractive optic is operable to diffract said image-bearing light beams into said substrate in an angularly encoded form, wherein said in-coupling diffractive optic comprises a first plurality of periodic in-coupling diffractive structures and a second plurality of periodic in-coupling diffractive structures;
an out-coupling diffractive optic formed along said substrate, wherein said out-coupling diffractive optic is operable to diffract said image-bearing light beams from said substrate in an angularly decoded form, wherein said out-coupling diffractive optic comprises a first plurality of periodic out-coupling diffractive structures having a periodicity equivalent to said first plurality of periodic in-coupling diffractive structures, and a second plurality of periodic out-coupling diffractive structures having a periodicity equivalent to said second plurality of periodic in-coupling diffractive structures,
a first intermediate diffractive optic located in a first optical path between said in-coupling diffractive optic and said out-coupling diffractive optic, wherein said first intermediate diffractive optic comprises a first plurality of periodic intermediate diffractive structures oriented parallel with said second pluralities of periodic in-coupling and out-coupling diffractive structures, and
a second intermediate diffractive optic located in a second optical path between said in-coupling diffractive optic and said out-coupling diffractive optic, wherein said second intermediate diffractive optic comprises a second plurality of periodic intermediate diffractive structures oriented parallel with said first pluralities of periodic in-coupling and out-coupling diffractive structures,
wherein a portion of said first intermediate diffractive optic is located at least partially about said in-coupling diffractive optic, and
wherein a portion of said second intermediate diffractive optic is located at least partially about said in-coupling diffractive optic.

12. The image light guide for conveying a virtual image according to claim 11, wherein an arcuate space is located between said in-coupling diffractive optic and said first intermediate diffractive optic and said second intermediate diffractive optic, wherein said arcuate space does not include any periodic diffractive structures.

13. The image light guide for conveying a virtual image according to claim 11, wherein a portion of image-bearing light incident upon said in-coupling diffractive optic propagates toward said out-coupling diffractive optic between said first and second intermediate diffractive optics.

14. The image light guide for conveying a virtual image according to claim 11, wherein said second plurality of periodic in-coupling diffractive structures is crossed with said first plurality of periodic in-coupling diffractive structures.

15. The image light guide for conveying a virtual image according to claim 14, wherein said first plurality of periodic out-coupling diffractive structures is crossed with said second plurality of periodic out-coupling diffractive structures.
